(19) United States
(12) Patent Application Publication
(10) Pub. No.: US 2005/0025900 A1
(43) Pub. Date: Feb. 3, 2005

(54) Formable non-stick powder coating

(76) Inventor: Jose Cavero, Chicago, IL (US)

Correspondence Address: LOUIS A. MORRIS;AKZO NOBEL INC., 7 LIVINGSTONE AVENUE, DOBBS FERRY, NY, 10522-3408, US

(21) Appl. No.: 10/860,945

(22) Filed: Jun. 4, 2004

Related U.S. Application Data
(60) Provisional application No. 60/476,508, filed on Jun. 6, 2003.

(51) Int. Cl. B05D 3/02

(52) U.S. Cl. 427/458; 427/180; 427/189

(57) ABSTRACT

The present invention comprises a process for coating a substrate with a polymeric coating that adheres to the substrate and that has non-stick properties, comprising the sequential steps of: a. Preparing a solid powder comprising a thermoplastic polymer and a thermoset polymer, at least one polymer having adhesive properties and at least one polymer having non-stick properties, or comprising a single polymer having both adhesive and non-stick properties; b. Applying the solid powder onto a substrate comprising a substantially flat surface; c. Heating the substrate to a temperature sufficient to cause the powder to become sufficiently fluid to coat said substrate; and d. Forming the coated substrate into the desired shape.

### CROSS REFERENCE TO RELATED APPLICATION

This Application claims priority from Provisional Application Ser. No. 60/476,508, filed Jun. 6, 2003, the entire content of which is incorporated herein.

### BACKGROUND OF THE INVENTION

1. Field of the Invention

The invention relates to a process for coating a substrate with a polymeric coating and forming the coated substrate into the desired shape.

2. Discussion of the Prior Art

The prior art is replete with non-stick coatings for cookware and bakeware, but a problem arises when a coated substrate is formed into a desired shape. The prior art coatings are not able to withstand the forming of the substrate without losing adhesion. An example of a typical prior art coating comprises a silicone-polyester resin.

Silicone-Polyester resin for powder coatings offer a variety of different properties much needed for the cookware and bakeware market. Although this resin is somehow flexible (2T), it does not have enough elongation to be deep drawn on Aluminum discs.

### SUMMARY OF THE INVENTION

In one embodiment, the present invention comprises a process for coating a substrate with a polymeric coating that adheres to the substrate and that has non-stick properties, comprising the sequential steps of:
a. Preparing a solid powder comprising a thermoplastic polymer and a thermoset polymer, at least one polymer having adhesive properties and at least one polymer having non-stick properties, or comprising a single polymer having both adhesive and non-stick properties;
b. Applying the solid powder onto a substrate comprising a substantially flat surface;
c. Heating the substrate to a temperature sufficient to cause the powder to become sufficiently fluid to coat said substrate; and
d. Forming the coated substrate into the desired shape.

Other embodiments of the invention concern details regarding process reactants and conditions and are set forth in the following detailed discussion.

### DETAILED DESCRIPTION OF THE INVENTION

The above process results in a formed coated substrate where the coating has not lost its adhesion in the course of forming the substrate. This is particularly important in the manufacture of housewares with non-stick coatings, such as pots, pans and bakeware.

Preferred non-stick polymers are fluoropolymers which are selected from the group consisting of PTFE(Polytetrafluoroethylene), copolymers of TFE(Tetrafluoroethylene) with such co-monomers as PMVE (perfluoromethylvinylether), PPVE (perfluoropropylvinyl ether), HFP(hexafluoropropylene), Ethylene, CTFE (Chlorotrifluoroethylene) and combinations of the above comonomers with TFE.

The preferred polymers with adhesive properties are selected from the group consisting of of Polyether Sulfones(PES), Polyarylsulfones(PAS), Polyphenyl Sulfide(PPS), Polyetheretherketones (PEEK), Polyimides(PI and Polyamideimides(PAI).

Preferred polymers with both adhesive and non-stick properties are selected from the group consisting of Silicones, Silicone polyesters, and Silicone Epoxies.

The preferred amount of fluoropolymer in the solid mixture is from about 1 wt. % to about 50 wt. %, while the preferred amount of polymer with adhesive properties in the solid mixture is from about 50 wt. % to about 95 wt. %.

The solid powder may be applied to the side of the substrate that will be the interior of the object of desired shape, the side that will become the exterior, or both.

The solid powder may contain both a high temperature resin for adhesion and a low surface energy polymer for non-stick properties, the solid comprising a one coat system.

The solid powder applied to the substrate may be as a multi-coat system where a first layer, or undercoat, is applied for adhesion to the substrate and one or more powders are applied over said first layer to provide release properties.

The solid powder may be from about 10-80 microns average particle size.

The powder may be applied in a layer about 20-60 microns thick, electrostatically onto the metal substrate, which is heated from about 370° C. to about 415° C. to cause the powder to become fluid.

The following examples illustrate the achievement of the present invention by comparing formed coated substrates prepared by the process of the invention with formed coated substrates prepared by prior art processes.

### EXAMPLE 1

In this case a bi-functional polyester, that contains both hydroxyl and carboxyl groups was employed. This resin is cured with glycidyl acrylic hardener and urethane crosslinker (isocyanate).

The formulation was as follows:

Formula code: XP-1083-4 Chemlon gray post-formable

| RM | Weight | Supplier |
|---|---|---|
| Fine Clad A-239-X | 51.0 | Reichhold |
| Fine Clad A-244-A | 7.7 | Reichhold |
| Huls B-1530 | 9.5 | Creanova |
| Benzoine | 0.35 | Various |
| Modaflow Powder III | 0.7 | Solutia |
| Modarez SAP | 0.3 | Synthron |
| Silvet 320-20-j | 3.0 | Silberline |
| Actiron DBT | 0.2 | Synthron |
| Ultramarine Blue 5008 | 0.17 | Various |
| Wollostonite M400 | 30.0 | Nyco |
| Irganox 1010 | 1.0 | Ciba |
| AFTER EXTRUSION | | |
| CT-1111-G | 0.1 | Cabot |
| AFTER GRINDING | | |
| PCF-625 | 1.0 | Alcan-Toya |

The above formulation was pulverized to 25% retention on mesh 325. It then was sprayed electrostatically on 2 mm thick sandblasted aluminum discs, and cured for 15 min. @450F.

The discs were post formed to a depth of 3 inches to form saucepans. The bottoms of the formed saucepans were machined.

The saucepan was filled with water and left boiling for 5 hours. The color and gloss retention on the saucepan's walls were found to be excellent. The coating adhesion after the boiling water test was 100%.

1. A process for coating a substrate with a polymeric coating that adheres to said substrate and that has non-stick properties, comprising the sequential steps of:
a. Preparing a solid in a powder form comprising a thermoplastic polymer and a thermoset polymer, at least one polymer having adhesive properties and at least one polymer having non-stick properties, or comprising a single polymer having both adhesive and non-stick properties.
b. Applying said solid powder onto a substrate comprising a substantially flat surface;
c. Heating said substrate to a temperature sufficient to cause said powder to become sufficiently fluid to coat said substrate; and
d. Forming the coated substrate into the desired shape.

2. The process of claim 1 wherein said non-stick polymers are fluoropolymers which are selected from the group consisting of PTFE(Polytetrafluoroethylene), copolymers of TFE(Tetrafluoroethylene) with such co-monomers as PMVE (perfluoromethylvinylether), PPVE (perfluoropropylvinyl ether), HFP(hexafluoropropylene), Ethylene, CTFE (Chlorotrifluoroethylene) and combinations of the above comonomers with TFE.

3. The process of claim 1 wherein said polymers with adhesive properties are selected from the group consisting of of Polyether Sulfones(PES), Polyarylsulfones(PAS), Polyphenyl Sulfide(PPS), Polyetheretherketones (PEEK), Polyimides(PI and Polyamideimides(PAI).

4. The process of claim 1 wherein said polymers with both adhesive and non-stick properties are selected from the group consisting of Silicones, Silicone polyesters, and Silicone Epoxies

5. The process of claim 1 wherein the amount of fluoropolymer in said solid mixture is from about 1 wt. % to about 50 wt. %.

6. The process of claim 1 wherein the amount of polymer with adhesive properties in said solid mixture is from about 50 wt. % to about 95 wt. %.

7. The process of claim 1 wherein said powder is applied to the side of the substrate that will be the interior of said object of desired shape, the side that will become the exterior, or both.

8. The process of claim 1 wherein said solid contains both a high temperature resin for adhesion and a low surface energy polymer for non-stick properties, said solid comprising a one coat system.

9. The process of claim 1 wherein powder applied to said substrate may be as a multi-coat system where a first layer, or undercoat, is applied for adhesion to said substrate and one or more powders are applied over said first layer to provide release properties.

10. The process of claim 1 wherein said powder is from about 10-80 microns average particle size.

11. The process of claim 1 wherein said powder is applied 20-60 microns electrostatically onto said metal substrate, which is heated from about 370° C. to about 415° C. to cause said powder to become fluid.
